(19) United States
(12) Patent Application Publication
(10) Pub. No.: US 2007/0068986 A1
(43) Pub. Date: Mar. 29, 2007

(54) T locking set for bicycle seat bag

(75) Inventors: Chien-Ping Lien, Shu-Lin City (TW); Kuo-Ping Ho, Taipei (TW)

Correspondence Address: LEONG C LEI, PMB # 1008, 1867 YGNACIO VALLEY ROAD, WALNUT CREEK, CA, 94598, US

(73) Assignee: HO, Kuo-Ping

(21) Appl. No.: 11/268,535

(22) Filed: Nov. 8, 2005

(30) Foreign Application Priority Data
Sep. 28, 2005 (TW) 094216876

(51) Int. Cl. B62J 9/00

(52) U.S. Cl. 224/427

(57) ABSTRACT

A T locking set for a bicycle seat bag is provided with a T rack and a clamping plate integrally formed therewith. The clamping plate is disposed on the top of the seat bag, while a pressing plate is correspondingly provided inside the seat bag, such that a bolts can go through the pressing plate and fastened to the clamping board, and that the T rack can be combined on the top of the seat bag. Two bars are extended from the respective ends of the T rack, whereas a clamping groove is formed between the respective bars and the clamping plate for clamping the two posts under the seat. A Velcro® or a U locking base is provided at the front end of the seat bag for firmly fastening the seat bag under the seat.

### BACKGROUND OF THE INVENTION

(a) Technical Field of the Invention

The present invention relates to a T locking set for a bicycle seat bag, which can be combined to the bicycle seat with easy installation and detachment, and firmly fastened to the seat.

(b) Description of the Prior Art

In respect of locking devices for fastening bicycle seat bag, the known prior arts includes U.S. Pat. No. 5,245,517, the point of which is that the seat bag has a T clamping bar on the top, and a U clamp at the front end, is provided above the bag, thereby the T clamping bar will clamp on the two bars under the bicycle seat, and is pushed forwardly until the U clamp is completely lock on the seat post to firmly fasten.

There is further U.S. Pat. No. 5,127,563, which is characterized in that the seat bag has a T clamping bar on the top, and a Velcro® at the front end. When in use, the T clamping bar is switched to slightly incline for entering between the two posts under the bicycle seat, and then the T clamping bar is switched back; the Velcro® at the front end of the seat bag is fastened to the seat post to firmly hold the seat post. U.S. Pat. No. 5,127,563 (a shown in FIGS. 1 and 2) is provided with an anti-slip locking device 11 and a support 12 installed inside of the seat bag. By way of a screw 14, the anti-slip locking device 11 is fastened outside of the seat bag. However, an inclined surface 16 is provided under each of the two feet 15 for locking the two posts 17 under the bicycle seat. As the distance between the two posts 17 is fixed, the distance between the two inclined surfaces 16 should be fixed as well, such that when the anti-slip locking device 11 is locked between the two posts 17 under the bicycle seat, it can be vertically held and fastened to the posts 17. As the posts 17 are made of metal, it is very likely that they become transformed after being push outwardly for a long time, rendering a noise occurred by the seat bag when the bicycle passes a rugged road.

### SUMMARY OF THE INVENTION

The primary purpose of the present invention is to provide a T locking set for a bicycle seat bag, which can be easily installed and detached with utilizing any tool, allowing the user to use it conveniently.

The secondary object of the invention is to provide a T locking set for a bicycle seat bag, which is easily operated and can be firmly combined to the bicycle seat bag.

To obtain the above objects, the T locking set of the invention is made of plastic and rubber, is provided with a T rack and a clamping plate integrally formed therewith. The clamping plate is disposed on the top of the seat bag, while a pressing plate is correspondingly provided inside the seat bag, such that a bolts can go through the pressing plate and fastened to the clamping board, and that the Track can be combined on the top of the seat bag. Two bars are extended from the respective ends of the T rack, whereas a clamping groove is formed between the respective bars and the clamping plate for holding the two posts under the seat. A Velcro® or a U locking base is provided at the front end of the seat bag for holding the seat bag on the seat post, thereby firmly fastening the seat bag under the seat.

To completely appreciate these and other objects of the present invention as well as the invention itself, all of which will become apparent to those skilled in the art, the following detailed description of the invention and the claims should be read in conjunction with the accompanying drawings.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a bicycle utility seat bag according to the prior art.

FIG. 2 is a cut-away view showing the bicycle utility seat bag of the prior art after being assembled.

FIG. 3 is an exploded view of the invention.

FIG. 4 shows combination of the invention with a bicycle seat bag.

FIG. 5 shows locking the invention to the posts under the seat.

FIG. 6 is a bottom view of an embodiment of the invention.

FIG. 7 is a side view of an embodiment of the invention.

FIG. 8 is an exploded view of the U locking base of the invention.

FIG. 9 shows combination of the U locking base with the seat bag.

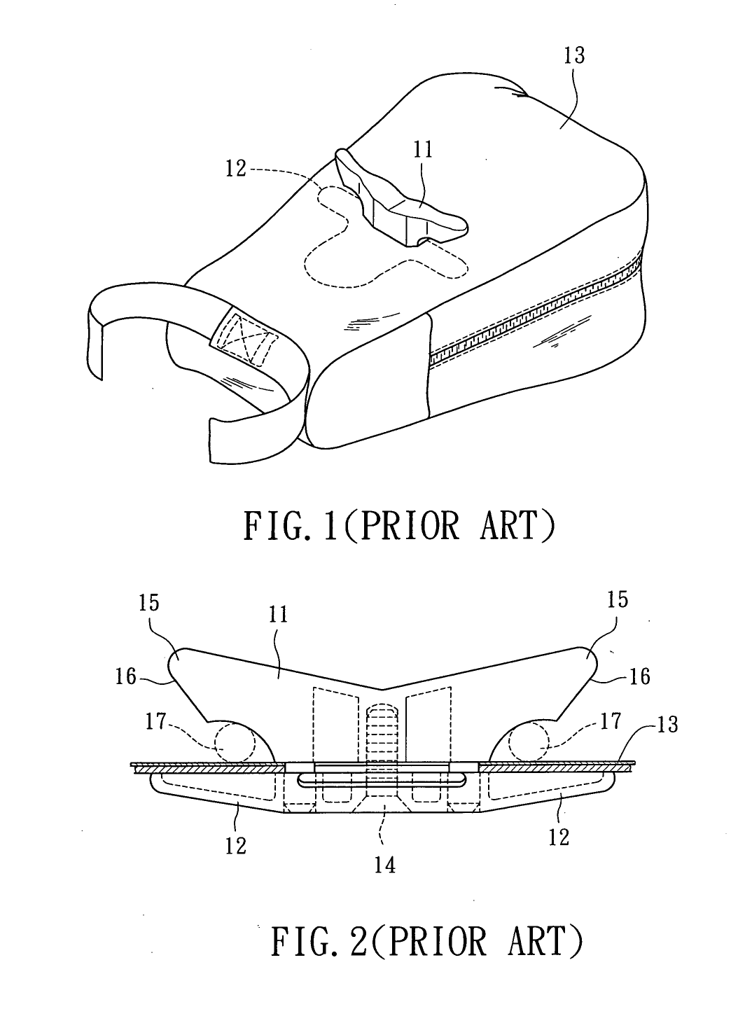

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

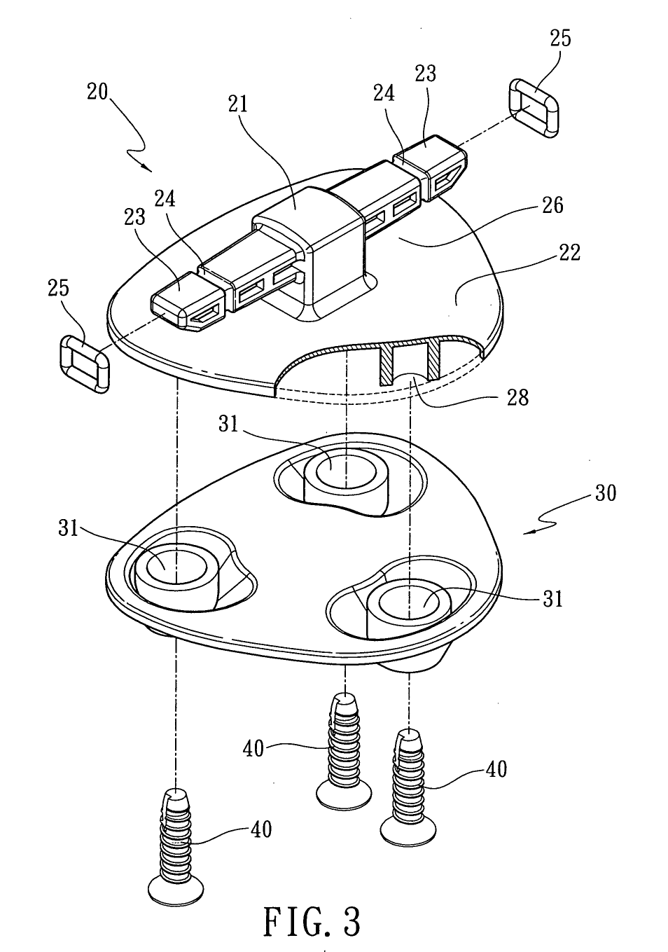

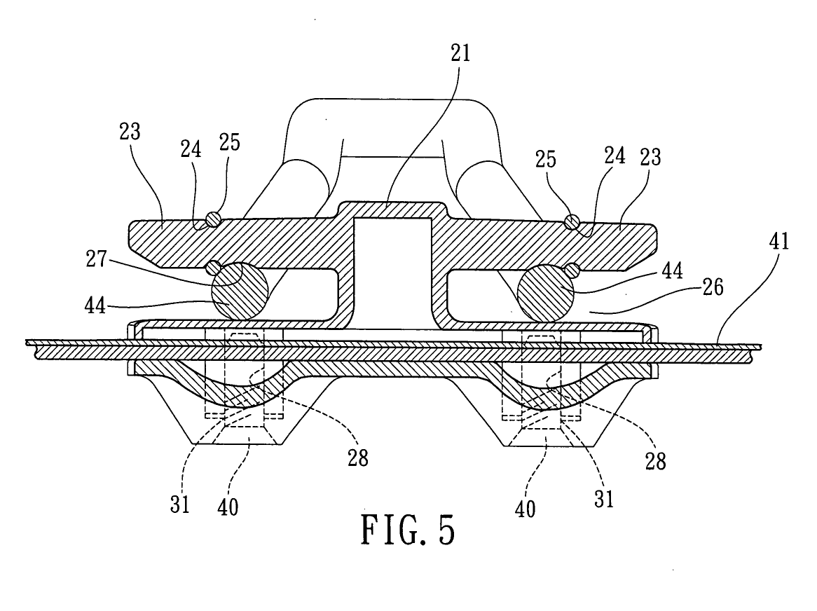

As shown in FIGS. 3 to 5, the T locking set of the invention is composed of a locking device 20 outside of the seat bag, a pressing plate 30 inside of the seat bag, and pluralities of bolts 40.

The locking device 20 has a T rack 21 and a clamping plate 22. Two bars 23 are extended from the respective ends of the T rack 21, whereas a clamping groove 24 is formed between the respective bars 23 and the clamping plate 22 for receiving a rubber ring 25. The clamping plate 22 is combined with the T rack 21 integrally and vertically, which forms a [symbol] shape cross section. A clamping groove 26 is formed between the respective bars 23 and the clamping plate 22; the underside of each of the bars 23 forms an arc surface adjacent to the inner side of the clamping grooves 26; and three screw holes 28 are provided on the bottom of the clamping plate 22.

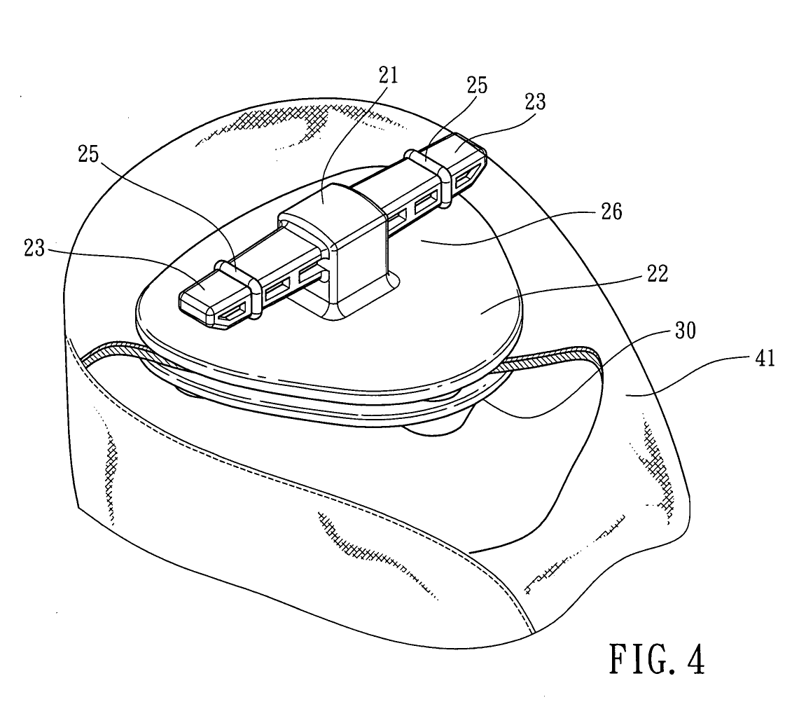

The pressing plate 30 has three through holes 31, such that bolts 40 can go through the through holes 31 on the pressing plate 30 and be fastened to the screw holes 28, thereby when the seat bag 41 is firmly clamped by the clamping plate 22 and the pressing plate 30, the T rack 21 can be fastened to the top of the seat bag 41 (as shown in FIG. 4).

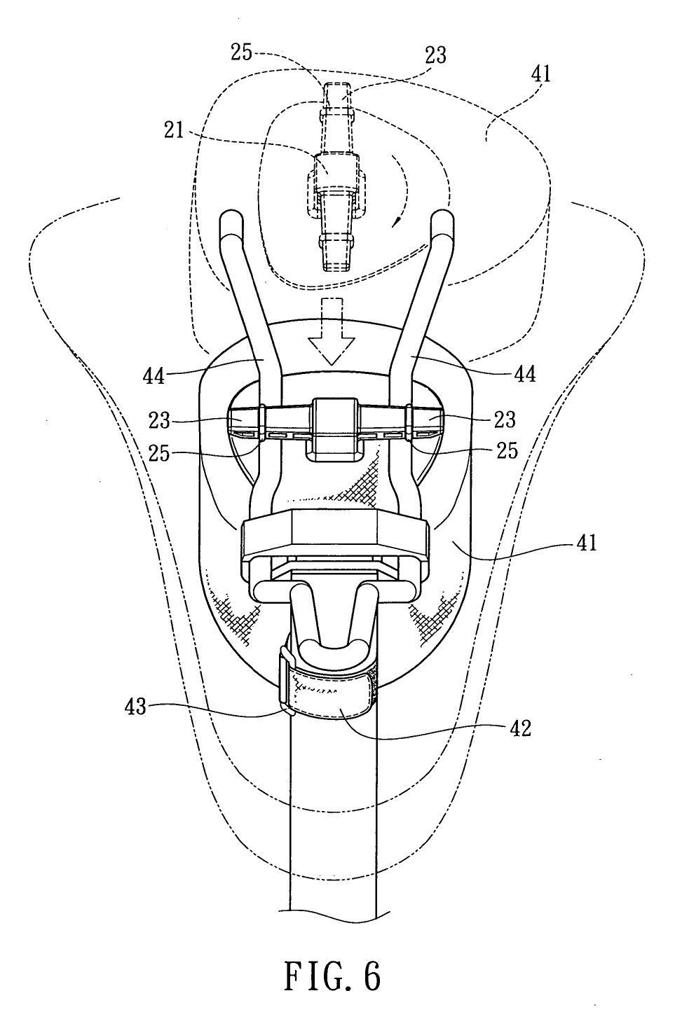

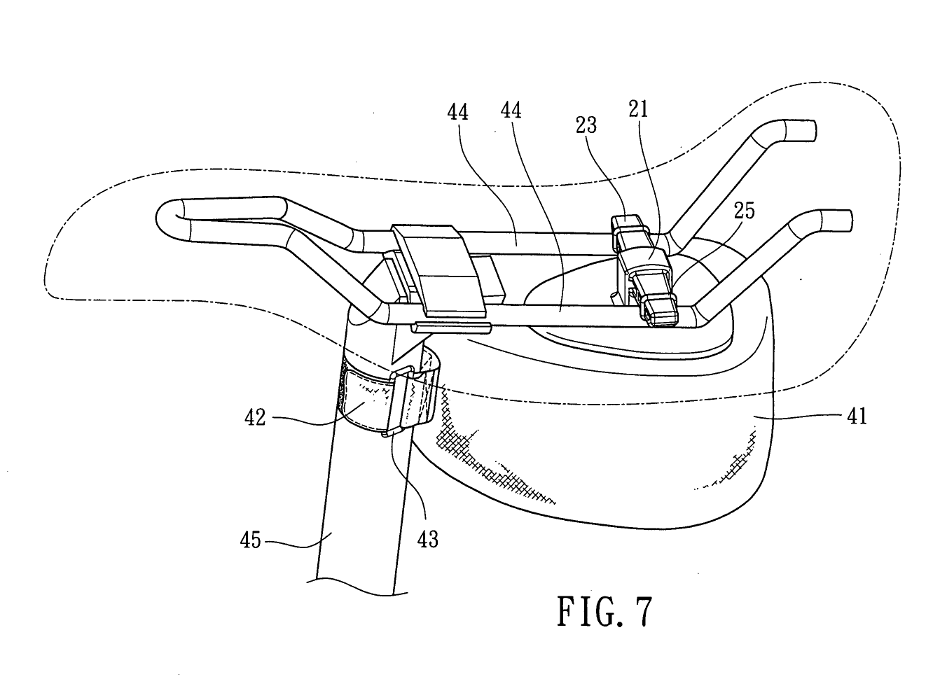

Referring to FIGS. 6 and 7, the front end of the seat bag 41 is provided with a Velcro® 42 sewn to the bag, and a locking ring 43. When in use, the user switches the T rack 21 to allow the bars 23 enter between the two posts 44 under the seat, and then switches the T rack 21 to make the clamping grooves 26 under the bars 23 to clamp the two posts 44 by way of the extensible and resilient characteristics of the plastic material of the bars 23, the posts 44 can be firmly clamped. The Velcro® 42 at the front end of the seat bag 41 goes around the seat post 45, and then goes through the locking ring 43 to fasten, thereby obtaining a perfect fastening effect by holding the seat bag 41 at three positions.

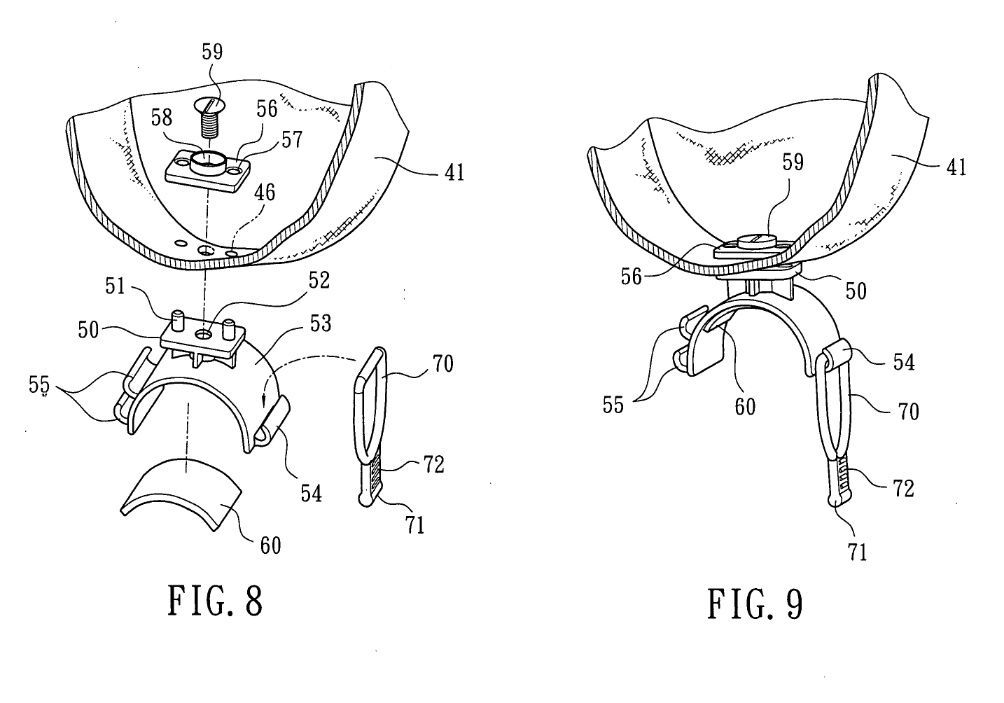

As shown in FIGS. 8 and 9, the front end of the seat bag 41 can alternatively be provided with a U locking base 50, one side which is protrusively provided with two positioning posts 51, between which a screw hole 52 is provided. A U frame 53, which is provided on the other side of the U locking base 50, is provided with a hook 54 at end, two locking hooks 55 at the other end, and a soft spacer 60 under the U frame 53. A rubber ring 70 is held on the hook 54, with the other end provided with an extruding pull 71 on which anti-slip roughness 72 is provided. In combining the U locking base 50 to the front end of the bicycle seat bag 41, the three through holes 46 at the front end of the seat bag 41 need be aimed at the U locking base 50 such that the two positioning posts 51 may go through the corresponding through holes 46; and then the positioning holes 57 the clamping piece 56 are mounted onto the positioning posts 51. A bolt 59 goes from the interior of the seat bag 41 through the screw hole 58, and finally fastened to the screw hole 52.

The U locking base 50 leans against the seat post 45, and the rubber ring 70 goes around the seat post 45 for fastening to either of the hooks 55.

Concluded above, the invention discloses a T locking set for a bicycle seat bag, which can be freely fastened under the seat. As the design is simple, the user can have great convenience in DIY. Although specific embodiments have been illustrated and described, it will be obvious to those skilled in the art that various modifications may be made without departing from what is intended to be limited solely by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A T locking set for a bicycle seat bag, being composed of a T rack, a pressing plate and several bolts, characterized in that:
the bottom of the T rack is combined with a clamping plate; two bars, each of which has a limit groove at the rear end for mounting a limit rubber ring, are extended from the respective ends of the T rack; a clamping groove is formed between the bar and the clamping plate, the bottom of which is provided with screw holes;
the pressing plate is provided with through holes for receiving screws going from the bottom of the pressing plate and being fastened to the screw holes on the clamping plate; and
the seat bag is provided with a Velcro® and a locking ring.

2. The T locking set for a bicycle seat bag according to claim 1, wherein an arc surface is provided on the underside of the respective bars, adjacent to the limit groove.

3. The T locking set for a bicycle seat bag according to claim 1, wherein a U locking base can be provided at the front end of the seat bag.

4. The T locking set for a bicycle seat bag according to claim 1, wherein one end of the U locking device is provided with two positioning posts, between which a screw hole is provided, while under the positioning posts, a U frame, which has two hooks at one end, and a hook at the other end for combining with a rubber ring, is provided.
